(19) United States
(12) Patent Application Publication
(10) Pub. No.: US 2003/0146963 A1
(43) Pub. Date: Aug. 7, 2003

(54) Micro-diffusion ink and ink jet printing process

(76) Inventor: John Murray, Lake Havasu, AZ (US)

Correspondence Address: Marvin E Jacoba, Koppel & Jacobs, 2151 Alessandro Drive Suite 215, Ventura, CA, 93001, US

(21) Appl. No.: 10/275,021

(22) PCT Filed: Nov. 8, 2001
(86) PCT No.: PCT/US01/50179

(51) Int. Cl. B41J 2/01

(52) U.S. Cl. 347/103

(57) ABSTRACT

An ink composition for ink jet printing on substrates, preferably fibrous fabric materials comprising a suspension of uniform, very tine, mainly spheroidal ink particles in aqueous medium to form a stable colloidal suspension. The particles may contain a waxy coating to prevent agglomeration and to aid in spheroidization of the particles. The presence of a small amount of solvent for the dye particles during milling also contributes to formation of uniform, spheroid particles.

### TECHNICAL FIELD

This application is a continuation-in-part of a Provisional application Serial No. 60/247,087, filed Nov. 9, 2000.

### FIELD OF THE INVENTION

This invention relates to a novel ink comprising fine, solid dyes dispersed in an aqueous medium and to a method of printing by emitting droplets of the ink, preferably through a piezoelectric printhead onto the surface of a transfer sheet or directly onto substrates, such as a sheet of fabric.

### BACKGROUND OF THE INVENTION

Ink jet printers have developed to the point that they provide business quality printing at moderate cost. They are now the printer of choice for home and many business applications.

Most of the inks used in these printers contain soluble colorants and produce vibrant and clear monochrome and multicolor images detailed prints without clogging jet printer nozzle heads. Ink jet inks containing dissolved dyes create color correct final images. However, soluble dyes are susceptible to fading, especially from UV light. Water-soluble dyes that are deposited on filaments or fibers in fabric substrates dissolve during hot water washing resulting in faded images.

One ink jet printing process used to form images on fabrics uses sublimable dyes, which are dispersed in an emulsified medium. Usually a reverse image is first printed on a transfer sheet such as paper without activation of the dyes.

The image on the transfer sheet produced by emulsified inks of the prior art are dull and is not representative of the final image. The transferred image is heated to activate the dyes and after phase change a brighter differently colored image is formed. Therefore, it is very difficult to do color correction before making a final print. The final image is not permanently fixed to the fabric and fades when subjected to repeated washing in hot or cold water. The sublimable inks become dissolved in the wash water and/or resublime resulting in a faded image.

Most companies that use ink jet printers to print an image on fabrics have depended upon the use of sublimable dyes in order to produce images onto fabrics such as polyester based substrates. One ink jet imaging process for printing graphics onto fabrics involves first forming an ink jet image on a temporary substrate. Paper is normally used as the temporary receptor medium and the temporary image is later transferred to a final substrate by the action of heat and pressure using a heated platen press.

The problem with sublimable ink-jet dye compositions is their inability to effectively penetrate and thoroughly permeate woven fabrics, textiles, apparel or coated ceramics. Another problem with conventional sublimable dye ink compositions is their inability to perform satisfactorily in the transfer process in which heat is used alone without any applied pressure. Another problem with conventional sublimable ink dye compositions is their inability to perform satisfactorily in the transfer process in which pressure is used alone with heat at a temperature that does not activate the heat activated dyes. Another drawback of prior art ink jet images produced with sublimable dye compositions is that they are poorly fixed, or anchored to the final substrate. This results in a tendency to fade upon continued exposure to heat as the fixed image will re-sublime and the sublimed dye will travel in all directions yielding a poorly fixed, and blurry image. Eventually the dye will evaporate from the final substrate and the image fades over time.

Another problem with conventional sublimable ink dye compositions is that they are not “color correct: when the image is first printed. Heat must be used in order for the colors to activate onto the final substrate and print to the color that is desired. Thus, conventional sublimable ink dye compositions cannot be printed onto the final substrate without an intermediate image being formed on a transfer sheet.

For similar reasons, sublimable dye ink jet inks of the prior art when printed upon a temporary substrate for subsequent transfer, must be transferred to the-final substrate within a period of 24 to 48 hours, otherwise severe image bleeding and resolution loss will occur. Upon prolonged storage of these temporary images, dye oxidation and fading is an additional problem.

| Pat. No. | Patentee | Title |
|---|---|---|
| 5,487,614 | Hale | Method of printing a multiple |
| | | color image using heat sensitive |
| | | inks |
| 5,488,907 | Xu & Hale | Permanent heat activated transfer |
| | | printing process and composition |
| 5,601,023 | Hale & Xu | Permanent heat activated transfer |
| | | printing process and composition |
| 5,640,180 | Hale & Xu | Low energy heat activated transfer |
| | | printing process |
| 5,642,141 | Hale & Xu | Low energy heat activated transfer |
| | | printing process |
| 5,734,396 | Hale & Xu | Method of printing a multiple color |
| | | image using heat sensitive inks |
| 5,830,263 | Hale & Xu | Low energy heat activated transfer |
| | | printing process and composition |

Statement of the Prior Art

The '614 patent relates to a color thermal ink jet printer utilizing, water-based inks containing colorants that are either dissolved dyes or dispersed pigments. This patent discloses a phase change ink jet printer uses waxy, low melting, sold colorants.

Further, the novelty of this Hale patent lies in the use of a surface preparation material either incorporated in the ink jet ink itself, or applied separately, in order to bond or permanently affix, the sublimation dye solids of the ink to a substrate having a cotton component, or other component which is absorbent or porous.

The '907 patent is limited to jet printers which use emulsified liquid inks.

The '023 patent relates solely to inks that are oil-in-water (o/w), or water-in-oil (w/o) emulsions. After Example 1, the patent states:

“Free flow and bubble jet printers are designed to be used with liquid inks, but not with inks having solid particulate within the liquid. The presence of solid materials clogs the orifice or nozzle of the printer. Further, liquid ink compositions into which a solid particulate is placed or dissolved are not homogeneous over time. The solid ink particles in the mixture settle from the liquid toward the bottom of the ink container. This settling increases the clogging of the orifice. Further, print quality is affected if the ink is not consistent.” In Example 2 after the ink is mulled, solvent is added to dissolve the ink particles before emulsification.

In method patent '180, inventors Hale and Xu teach the use of emulsifying agents in order to reduce the energy required to activate a limited group of sublimable dyes.

The '141 patent has the same disclosure as the '180 patent.

In the '396 patent, an emulsifying enforcing agent is an essential component of the ink disclosed in the patent. The solid dye particles are dissolved before emulsification in water.

The '263 patent discloses an inkjet emulsion formulation containing a sublimable dye.

Statement of the Invention

An improved ink jet composition process is provided according to the invention that provides the same true color images in an intermediate temporary transfer print as in a final print. The final image is permanent and bright and does not discolor or fade after repeated washing of the image. Color of the image can be corrected in the intermediate stage since there is no phase change or sublimation of the colorant during printing of the final image.

The ink composition of the invention is in the form of a dispersion of very fine, dye solid particles in an aqueous medium. The solid particles are preferably uniform in size and spheroidal in shape to avoid agglomeration, settling and blockage of piezoelectric print heads. This ink composition preferably contains at least 50% of sub-micron particles of the order of less than 0.1 microns (100 nm) in diameter and less than about 0.1% by weight of agglomerates remain in suspension and do not clog piezoelectric print heads. The compositions are believed to result in colloidal suspensions with the particles subject to Brownian movement. During transfer of the ink of the invention to a fabric the very fine particles embed deeply into the fibers, especially when the filaments are heated to above their glass transition temperature and become flexible to enhance penetration of the solid particles. The embedded particles are not dislodged during repeated washing and the image remains bright and distinct as compared to sublimation transfer images which can dissolve, sublime or be abraded from the surface of the filaments forming the fiber.

The invention also relates to an improved process and system for forming the very fine, uniformly shaped dye particles dispersed in an aqueous carrier and to improvements in transfer sheets and in the transfer process for forming stable images on substrates such as fabric.

Ink jet ink formulation methods of the prior art have included the use of high shear mixing equipment and colloid mills for dye particle dispersion. The invention emphasis intensive particle size reduction such as in a three-roll mill, or in a fluid energy mill, such as a sub-micron fluidizer mill to further reduce the size of the solid dye particles. Ink jet formulation methods of the prior art have relied on emulsification process to obtain a uniform ink. Inks containing suspension of solid dye particles have problems with settling and agglomeration of the particles. Particle agglomeration or aggregation is reduced in the present invention by milling the particles to a very fine, uniform shape and size to form colloidal suspensions in which the particles move by Brownian movement and do not settle. The presence of wax compounds during intensive particle size reduction is believed to aid spheroidization and wax coated particles are less likely to stick together. Addition of a minor amount of solvent for the particles is believed to soften the particles which contribute to spheroidizing the solid dye particles and make them consistent in size to limit the area of particle-to-particle contact thus minimizing agglomeration, sedimentation and print head nozzle clogging.

It has been discovered in accordance with the invention that the dyes in images produced according to the invention are capable of transferring to the final substrate at a temperature that is lower than the standard heat activation temperature of a sublimable dye.

This invention provides a novel ink jet ink composition for a “micro-diffusion” imaging process which provides extraordinary image resolution, stability, permanence, abrasion resistance, and UV fade resistance. At the same time, the ink jet ink composition of this invention, by virtue of its extremely fine, stable dispersed dye phase, demonstrates a typical shelf life of two years, compared with prior art sublimable, emulsion dye ink compositions which can only be stored for up to six months, after which sedimentation or print head nozzle clogging will likely occur.

The ink jet ink composition of this invention, can be used to print graphic or text images created by a computer, scanner, or computer software by an ink jet printer, such as an on-demand thermal, bubble-jet, or piezo printhead, or a continuous flow printhead, such as the Iris Graphics printhead using Hertz piezo crystal technology. The image is then printed directly, by placing the substrate into the printing apparatus and creating the image by emitting droplets onto the substrate. The image can then be fixed by heat using heat lamps, infra-red lamps, a heat press, heated impingement air, or other thermal means. Alternately, the imaging process of this invention can be performed indirectly, by forming the image on a temporary substrate, such as paper, and then transferring the image to a final substrate such as woven fabric using a combination of heat and-pressure.

Most importantly, the ink jet ink composition and its method of manufacture enables the creation of a disperse dye ink jet image on a transfer substrate that can be stored for periods up to one year without significant image bleeding, oxidation, fading or degradation as occurs with prior art emulsion, sublimation ink. The present invention provides an improved method and means for forming a stable and permanent ink jet image on a substrate using a class of colorants known as disperse dyes. The present invention ensures that the ink jet image thus formed upon, or transferred to a fabric, textile, apparel or garment, such as an emblem, logo, insignia, or other graphic will resist at least 25 wash cycles in an industrial or commercial laundry.

The ink jet images using the solid dispersion inks of the invention formed upon, or transferred to a fabric, textile, apparel, garment, ceramic, glass, plastic, leather or other receptor surface are well anchored to and anchored into the dye receptive fiber, coating, or other compatible substrate material as to resist heat, abrasion and fading after prolonged UV exposure. This invention provides an ink jet ink composition having a dispersed phase so finely divided and so free of agglomerates as to prevent printhead clogging.

This invention provides a disperse dye ink composition capable of producing emblems, logos, insignia and other graphics on uniforms, textiles and apparel with more brilliant colors and with greater image density than prior art ink jet dye compositions. The ink composition of the invention so stable and resistant to sedimentation as to enable ink filled cartridges to be stored for periods of up to two years without any sign of decomposition, sedimentation, color shift or oxidation.

These and many other attendant features and advantages of the invention will become better understood as the invention becomes better understood by reference to the following detailed descriptions when considered in conjunction with the accompanying drawing.

### BRIEF DESCRIPTION OF THE DRAWINGS

The FIGURE is a production flowsheet diagram illustrating the method in which the ink jet ink of the present invention is prepared.

### DETAILED DESCRIPTION OF THE INVENTION

Referring now to the FIGURE, a disperse of dye in powder form and high purity, deionized water (10) is fed as a paste to a conventional, water-cooled 3-roll mill (11). The paste mixture is milled at extremely close tolerances for about five minutes to achieve a first particle size reduction. A small amount of solvent to soften the dye particles without dissolving them can be present during the size reduction steps of the process.

After milling, the paste is let down with deionized water (12) and fed to a homogenizer (13), such as a Gaulin 15M8TA 2-stage Homogenizer, operating at pressures in the range of 3,000 to 4,000 pounds per square inch (psi). The homogenizer breaks up agglomerates and ensures that the finely ground particles remain separate and discrete. Alternately, a second stage mixing and milling device such as the Avestin, Inc. Model C5 Homogenizer, can be used to achieve the same result but at pressures in the range of 20,000 to 30,000 psi.

After homogenization, a small quantity of a diluent mixture (14) comprised of a mixture of an alkylene glycol such as dipropylene glycol, a polar aprotic solvent such as dimethyl sulfoxide (DMSO) and/or an alkanol such as methyl alcohol, is combined with the ink and the mixture fed to a “Sub-Micronizer” (15). This device is essentially a modified colloid mill having an intense rotational action. The diluent is blended into the recirculating ink stream as it passes through this third stage mill for about five minutes.

Separately, a liquid mixture of stabilizing chemicals and additives (16) is prepared in a stirred vessel. The stabilizer contains pH adjusting chemicals, surfactants to maintain particles in suspension, and a wax water-based additive which serves as a detackifying agent to prevent particle-to-particle adhesion and encapsulates each dye particle, protecting it from oxidation in ambient air or in laundry wash cycles. The stabilizer can also contain a small quantity of a textile dye solvent such as thiodiglycol (thiodiethylene glycol) which acts in conjunction with the extreme hydraulic vortex forces and rotational fluid motion within the sub-micronizer chamber to reduce the dye particles to a uniform size while causing these particles to assume a spheroidal shape.

After the stabilizer mixture is added, the sub-micronizer is operated for about one hour at about 2,500 psi head pressure. An ink sample is taken and examined under the microscope to ensure that the mixture is free of agglomerates and that a uniform particle size distribution has been achieved and that the particles have a near spheroid shape.

In place of the sub-micronizer, other devices can be used, among such as Cherry-Burrell Viscolizer, a Gaulin Colloid Mill, a Charlotte Colloid Mill, or the like. These devices subject the mixture to an intense hydraulic shear action in a rotary, spiral flow pattern that in the presence of a low concentration of dye solvent spheroidizes the disperse dye particles.

Most of these mills pump the fluid mixture under high pressure through a narrow opening between a valve plug and its seat. As a result, the stream develops a very high velocity as it passes through the extremely small opening. The combination of this velocity and the frictional drag of the material in actual contact with the surfaces of the valve plug and seat, causes extreme internal shear to develop within the dispersion, tending to break down the particle size of the dispersed phase. An explosive effect also occurs as the particles are released from the zone of high pressure to atmospheric pressure. A variety of these devices is available, some of which combine the action of grinding, mixing and homogenizing. The preferred colloid mills, for the purposes of the present invention, are those that through the combination of chemical solvent attack and rotational hydrodynamic forces, reduce particles to a uniform sub-micron size in the range of 0.01 to 0.5 microns (10 to 500 nm) while causing the dye particles to assume a spheroidal shape.

An improved ink for printing through a piezoelectric ink jet printhead is produced in accordance with the invention by subdividing and sheroidizing ink particles suspended in aqueous media optionally containing a small amount of ink solvent and a wax-surfactant stabilizer to form a suspension containing particles at least 50% by weight, of which are very smooth, spheroidal-like particles having a particle size smaller than 0.11 microns (100 nm).

The subdividing of the ink particles is preferably accomplished in several stages. Commercial ink jet dye particles, preferably having a molecular weight below 600 and are in the form of sharp, rough particles usually having a particle size from 1 to 10 microns are added to deionized water to form a paste containing from 10-90 percent by weight of particles, usually 40-60 percent. During the first milling stage the paste is ground in a 3 roll mill for a time sufficient to reduce the average particle size of the disperse dyes to a range of 0.1 to 5 microns, preferably about 0.7 to 1.10 microns.

The paste recovered from the first milling stage is diluted with deionized water to reduce the solids content of the resulting dispersion from 5 percent to about 25 percent by weight, preferably 10-15 percent by weight. In a second stage, the dispersion is fed through a homogenizer in a single pass reducing the average particle size to from-0.2 to 0.7 microns (200 to 700 nm), the range of most commercial disperse dye inks for ink jet printing.

The final size reduction is conducted in a submicronizer, preferably in 2 stages. In the first stage water soluble diluents such as from 0.1 to 2% by weight of an alkylene glycol containing from 2-5 carbon atoms and 2-10 hydroxy groups and from 0.01 to 0.5% by weight of a polar aprotic solvent such as dimethyl sulfoxide or an alkanol containing 1-6 carbon atoms such as methanol is gradually fed to the submicronizer for 5-30 minutes during processing of the dispersion to form a uniform dispersion.

The dispersion is again diluted by adding water to a concentration of from 5 to 12 percent by weight. Small amounts of surfactant stabilizing agents are added before the diluted dispersion is processed in a submicronizer for a period of 30 minutes to 120 minutes, preferably while maintaining the temperature of the dispersion below 90° C., preferably below 50° C. by passing cooling water through the submicronizer.

The surfactants are usually present in an amount below about 0.1 percent by weight and can be anionic, cationic or nonionic surfactants or mixtures thereof. Small further amounts of polar aprotic solvents can be added and the ph can be adjusted, if necessary.

Another optional additive is from 0.1 to 2 percent by weight of a water soluble or dispersable wax dispersion. The wax is believed to coat and lubricate the particles during submicronization and promotes spheroidization. The lubricated dye particles can more easily penetrate the filaments thus adding to permanence of the dyed image.

The principles and practice of this invention are further illustrated by, but not limited to the following examples:

### EXAMPLE 1

### Yellow Disperse Dye

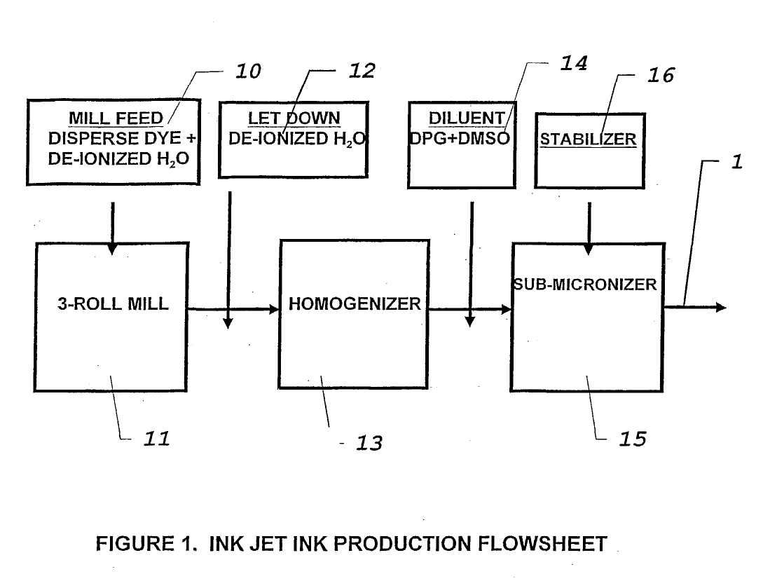

Equal quantities by weight of high-purity de-ionized water and yellow disperse dye, having a molecular weight preferably below 600, are mixed to form a paste and then ground on a standard 3-roll mill as depicted by 11 in FIG. 1. The mill feed used in this example was:

| | Paste Dispersion, grams |
|---|---|
| Yellow Dye C.I. #3 | 900 |
| High-purity, D.I. H₂O | 900 |
| Total | 1,800 |

The powdered yellow dye used in this example had an initial particle size in the range of 1.0 to 10.0 microns.

The mixture was processed for sufficient time to reduce the average particle size of the disperse dye to a range of 0.70 to 1.10 microns, about 5 minutes.

The 50 percent solids paste was let down (12) by the addition of 5,400 grams of de-ionized water, thereby reducing the solids content of the dispersion to 12.5 percent. The diluted paste dispersion was then sent through a homogenizer (13) for a single pass further reducing the average particle size to from 0.20 to 0.70 microns (200 to 700 nm), the size of most prior art disperse dye ink jet inks.

Upon entering the third milling stage of this example, the following diluent mixture was added to the ink dispersion, bringing the solids content further down to 12.37 percent:

| | Diluent, grams |
|---|---|
| Dipropylene glycol | 60 |
| Dimethyl sulfoxide | 15 |
| Total | 75 |

After recirculating the mixture through the submicronizer (15) for five minutes to ensure thorough mixing, the following stabilizer solution was added:

| | stabilizer, grams |
|---|---|
| Glycerine, USP | 15 |
| High-purity, D.I. H₂O | 3,000 |
| Dimethyl sulfoxide | 4 |
| N4 Surfactant. (Nonionic Surfactant) | 90 |
| Me60 Surfactant.* | 5 |
| Plattaren PS-400, wax stabilizer** | 65 |
| Sodium hydroxide, 10 Normal | 2 |
| Total | 3,181 |

*Ready to use Methyl Ester of Lauryl glucoside, Sodium Laureth sulfate and sodium Laureth-8 sulfate and sodium oleth sulfate.
**Alkyl Polyglycosides, Surfactant blend (personal care grade)

* Ready to use Methyl Ester of Lauryl glucoside, Sodium Laureth sulfate and sodium Laureth-8 sulfate and sodium oleth sulfate.

** Alkyl Polyglycosides, Surfactant blend (personal care grade)

Following the addition of this Stabilizer solution, the Sub-Micronizer was operated for a period of one hour. During this time, 40° F. cooling water was circulated through the cooling jacket of the mill. At the end of the one hour processing cycle, the temperature of the dye dispersion was found to be 80° F., having risen from about 70° F. at the time it was discharged from the single-pass homogenizer.

Two effects were observed in this example, and in other experiments leading up to the discovery of this invention. While examining under a microscope the ink jet ink product output from the sub-micronizer an increase in the uniformity of particle size distribution, with few if any agglomerates was discovered. The second effect is a reshaping of the dispersed dye particles from irregular, fragmented, aspherical particles to those with dull and rounded edges, approaching a spherical shape.

The first effect helps an ultrafine dispersion for improved image resolution, better substrate coverage and dye diffusion. The second effect decreases the probability of particle-to-particle adhesion by reducing available contact area and thereby increasing the stability of the ink by minimizing agglomerate formation. There was no evidence of presence of emulsification.

### EXAMPLE 2

A blue ink jet was produced using the equipment of Example 1 as follows:

Blue Ink Mixture:

600 ml de ionized water

370 ml Dye mixture (supplied)

2 ml Surfactant Mixture*

50 ml ThiodiGlycol Ultra

Run mixture in the Homogenizer (3-pass)

Then remove and add:

100 ml Dipropylene Glycol

15 ml Methyl Alcohol

Process the mixture for 1 hour in submicronizer, then add,

12 ML of Michelman 39235.

35 ML Surfactant Mixture*

Turn unit on and run for 1 hour with cooler at 40F After 2 hours take sample of the ink and check under microscope for particle size.

Seal Ink in Bottles

| | Stabilizer, cc |
|---|---|
| Glycerin | 20 |
| DMSO | 4 |
| NaOH | 2 |
| Surfactant | 120 |
| Me60 | 5 |
| Deionized Water | 500 |

### EXAMPLE 3

A red ink jet ink was produced following the procedure of Example 2 as follows:

Red Ink Mixture:

600 ml de ionized water

385 ml dye mixture

25 ml ThiodiGlyol Ultra

Run mixture in the Homogenizer (3-pass)

Then remove and add:

80 ml propylene Glycol

5 ml DMSO

10 ml sodium Hydroxide

20 ml Methyl Alcohol

Process the mixture for 1 hour in submicronizer, then add, 15 ml of Michelman 39235, 105 ml surfactant mixture as supplied. Turn unit on and run for 1 hour with cooler at 40F.

After 2 hours take sample of the ink and check under microscope for particle size.

Seal ink in bottles supplied.

The inks were analyzed by transferring a small amount of each ink to a pre-cleaned glass microscope slide and covered with a cleaned glass coverslip. Samples were initially examined using a polarized light microscope at magnifications up to 800×. Samples showed spherical particles that were observable with the light microscope. The particles were very small, approximately 0.2 to 0.5 microns (200 to 500 nm).

To determine if the particles were due to an emulsion or solid particles, portions of the inks were diluted with an equal volume of particle free, distilled, deionized water. The diluted ink sample were allowed to evaporate leaving a residue. The residues were examined using a second polarized light microscope with magnifications up to 1000×. The residues showed discrete particles. If the samples had been emulsions, we would expect a continuous thin film as the emulsion droplets broke open and spread over the substrate. These samples did not show this behavior and are, therefore, classified as suspensions of very small particles.

Ink Jet Printing

The yellow ink produced in Example 1 was installed in a cartridge supplying the printhead of an Epson PhotoStylus 900 ink jet printer driven by a PC computer equipped with appropriate software to generate a graphic, such as an emblem. That graphic was printed by the Epson 900 directly onto two polyester fabric shirts. The substrate is heated to a temperature below sublimation temperature but above the glass transition temperature of the polyester fibers. The fibers relax and permit deeper penetration of the ink particles. For example, the fabric was heated for 10 seconds in a platen press maintained at a temperature of 275° F.

One of the imprinted polyester shirts was then sent through an industrial laundry for 25 consecutive wash cycles and then compared with the unwashed shirt printed in the same manner. The difference in image density, color, and brilliance was barely perceptible.

Transfer Printing

Other suitable yellow dyes are yellow-C.I. #3, yellow C.I. #1, yellow C.I. #7, yellow C.I. #13, yellow C.I. #54, yellow dye C.I. #198. Printing process used above was repeated, except that an intermediate paper transfer substrate was used in place of a polyester shirt. The graphic was optically reversed in the computer so that the image would be right-reading after transfer. A transfer was then made using a heated platen press maintained at 400° F. A transfer time of 20 seconds was used to achieve the highest transfer efficiency without melting the polyester substrate receiving the image. Use of a layer of dye receptive polymer such as polyester on the transfer sheet improved clarity and definition of the transfer image.

The same printing processes used in Example 1 were repeated with the exception that disperse dye Blue C.I. #56 is substituted in place of Yellow C.I. #3. It was found that in the course of the dye diffusion, either by transfer or by direct printing, the hue of the final image was blue-green, or cyan, rather than blue. Other suitably blue dyes that are Disperse Blue C.I. #60 and Disperse and Disperse Blue #359.

### EXAMPLE 3

The same printing process used in Example 1 was repeated with the exception that disperse dye Red C.I. #1 is substituted in place of Yellow C.I. #3. It was found that in the course of the dye diffusion, either by transfer or by direct printing, the hue of the final image was blue-red, or magenta, rather than red suitable red dyes are Red C.I. #60 and Red C.I. #93.

### EXAMPLES 4

The ink jet ink making process used in Example 1 was repeated with the exception that for the direct and transfer printing steps all three ink jet inks-yellow, blue, and red-were deposited and superimposed in the same image area. The resultant image color was a deep, rich, neutral black.

### EXAMPLES 5

The ink jet ink preparation processes used in Examples 1-3 were repeated with the exception that the wax stabilizer, Plattern PS-400, was omitted. The images faded after a few hot temperatures, detergent washes and the shelf life of the images was significantly reduced from 2 years to 8 months as determined by accelerated aging tests.

The invention provides an improved disperse dye primarily for ink jet printing of emblems, logos, insignia and other graphics onto uniforms, garments and apparel. It is based upon a novel ink composition in conjunction with a unique milling, homogenizing and microfluidizing process that creates particles that are ultrafine in diameter and spheroidal in shape. At least 50 percent of the particles are 0.1 microns (100 nm) in diameter, or smaller and 90 percent of which are below 0.50 microns (500 nm). These sub-micron ink jet ink particles more readily diffuse into certain receptive fibers, such as polyesters and polyester/cotton blends, or into coatings containing a polyester resin. In addition, because the activation temperature, the temperature at which sublimation occurs, is higher than prior art dye sublimation ink jet inks, the mechanism by which the particles dye color fabrics is one of diffusion, or micro-diffusion, rather than sublimation. The composition of the ink jet inks of this invention can incorporate minute quantities of a disperse dye solvent, such as thiodiglycol (thiodiethylene glycol) which softens the surface of the dye particles during the final milling process, thereby causing them to approach a spheroidal shape under the extreme swirling and rotational hydraulic forces present in certain colloid mills. The resultant spheroidized particles are less prone to form agglomerates because they offer single point contact with other particles. Reducing agglomerate formation reduces the tendency of this ink to clog ink jet printhead nozzles while maintaining a low average particle diameter. The optional addition of certain wax type stabilizers offers additional protection for the dye particle from oxidation and attack by caustic laundry chemicals. In addition, the ink jet ink produced in accordance with the principles of this invention has better storage life, stability and permanence and when printed on intermediate transfer surfaces images can withstand long storage periods without bleeding or loss of clarity.

It is to be realized that only preferred embodiments of the invention have been described and that numerous substitutions, modifications and alterations are permissible without departing from the spirit and scope of the invention as defined in the following claims.

1. A method of printing a stable image on a substrate comprising fibers formed of a plurality of filaments comprising the steps of:
emitting a plurality of ink jet droplets from the orifice of a piezoelectric print head of an ink jet printer in the form of an image onto a surface of the substrate, said ink-droplets comprising a dispersion of very fine, solid dye particles at least 50% of which have a diameter below about 50 nm and said particles contain less than about 1% by weight of agglomerates larger than 50 nm dispersed in an aqueous medium and embedding said particles in the filaments of said fibers; and
fixing said image on said surface to remove said medium and to penetrate said dye particles into said fibers.

2. A method according to claim 1 in which the substrate is heated to a temperature above the glass transition temperature of the fibers to soften said filaments during emitting said particles onto said surface.

3. A method according to claim 2 in which at least 50% of the dye particles have a diameter less than 50 nm, 90% of the particles have a diameter less than 500 nm and contain less than 0.1% by weight of agglomerates larger than 10 nm.

4. A method according to claim 3 in which the particles form a colloidal dispersion in the aqueous medium.

5. Please Cancel

6. A method according to claim 4 in which the dye particles penetrate into the fibers and lock between the filaments to form a fixed image.

7. A method according to claim 6 in which said fabric is repeatedly washed without any significant fading of the fixed image.

8. A method according to claim 1 in which a plurality of droplets of ink jet ink of different colors is applied to said substrate to form a multicolor image.

9. Please Cancel

10. A method according to claim 1 further including the step of first forming said image on a temporary transfer sheet;
and transferring said image under pressure to a fibrous substrate.

11. A method according to claim 10 in which the transfer sheet is selected from paper and plastic films.

12. A method according to claim 11 in which the transfer sheet includes a dye receptive surface film.

13. A method according to claim 10 in which the fibrous substrate comprises polyester fabric.

14. A method according to claim 1 in which the fibrous substrate is formed of an ink jet dye receptive fibers.

15. A method according to claim 14 in which the fibers comprise polyester.

16. A method of forming an ink jet dye composition free of agglomerates and having good storage stability that forms bright, stable images on a substrate comprising the steps of;
forming a paste of solid, ink jet dye particles in an aqueous medium;
milling the paste to reduce the size of the dye particles;
diluting the paste with water to form a first suspension containing a minor amount a of water soluble organic solvent for the dye particles to soften the particles;
milling the first suspension in a homogenizer to reduce the presence of agglomerates and to spherodize the softened particles forming a homogenized first suspension; and
subjecting the homogenized first suspension to further milling in the presence of a dispersible wax while intensely rotating the suspension to further reduce the diameter of 50% the particles to below 50 nm and to coat the particles with said wax.

17. Please Cancel

18. A method according to claim 16 in which the solvents are at least one selected from the group consisting of a polar aprotic solvent, an alkylene glycol and a lower alkanol.

19. A method according to claim 18 in which the solvent comprises dipropylene glycol and dimethylsultoxide.

20. A method according to claim 16 in which the dye particle solvent comprises thiodiethylene glycol.

21. Please Cancel

22. A method according to claim 16 in which the dispersible wax is an alkylpolyglycoside surfactant.

23. A shelf-stable ink jet dye composition having reduced agglomerates and reduced settling of dye particles comprising;
ink jet dye solid particles having a uniform, spherical shape, at least 50% by weight having a particle size below 50 mm, dispersed in;
an aqueous medium containing less than 2% of a water miscible solvent for the dye particles and a minor amount of a water dispersible wax.

24. Please Cancel

25. Please Cancel

26. A dye composition according to claim 23 in which at least 50% of said particles have a diameter below 50 nm and 90% have a diameter below 500 mm.

27. A stable ink jet dye composition according to claim 23 in which the solvent is at least one selected from the group consisting of a polar aprotic solvent, an alkylene glycol and a lower alkanol.

28. A jet dye composition according to claim 23 in which the dye particle solvent comprises diepropylene glycol and dimethylsulfoxide.

29. A stable ink jet dye composition in the dye particles solvent comprises thiodiethylene glycol.

30. A stable ink jet dye composition in which the dispersible wax is an alkylpolyglycoside surfactant.

31. A stable ink jet composition according to claim 28 in which the solvent is present in an amount from 0.1 to 2% by weight and the water dispersible wax present in an amount from 0.1 to 2% by weight.
